(19) United States
(12) Patent Application Publication
(10) Pub. No.: US 2026/0103992 A1
(43) Pub. Date: Apr. 16, 2026

(54) SEALING DEVICE AND TURBOMACHINE COMPRISING THE SEALING DEVICE

(71) Applicant: SAFRAN AIRCRAFT ENGINES, PARIS (FR)

(72) Inventors: David Roger Pierre LEGRAND, MOISSY-CRAMAYEL (FR); Samia DAHITE, MOISSY-CRAMAYEL (FR); Hervé SIMONOTTI, MOISSY-CRAMAYEL (FR)

(21) Appl. No.: 19/113,049

(22) PCT Filed: Sep. 19, 2023
(86) PCT No.: PCT/FR2023/051431

§ 371 Date: Mar. 19, 2025

(30) Foreign Application Priority Data
Sep. 20, 2022 (FR) FR2209496

(51) Int. Cl. F01D 11/00; F01D 25/16; F16J 15/16; F16J 15/30; F16J 15/44

(52) U.S. Cl. CPC F01D 11/003; F01D 25/162; F16J 15/164; F16J 15/30; F16J 15/442

(57) ABSTRACT

A sealing device including a ring having a main sealing lip and a secondary sealing lip, where the main sealing lip presents an inner surface and the secondary sealing lip presents a radial surface, the sealing device also including a casing having a cylindrical portion and a radial portion, where the radial portion presents a contact surface, the ring being biased so as to apply the radial surface of the secondary sealing lip against the contact surface of the casing, where the sealing device presents at least one leakage path extending between the secondary sealing lip and the casing.

### FIELD OF THE DISCLOSURE

The present disclosure relates to a sealing device and a turbomachine comprising the sealing device. More specifically, the sealing device is intended to ensure sealing between a shaft and a separation wall separating a first housing and a second housing.

### PRIOR ART

In a turbomachine, multiple sealings must be ensured: the first housing may be intended to contain air and the second housing may be intended to contain only air or a mixture of air and oil. In particular, the sealing may aim to prevent the oil from passing from one housing to the other, but also to ensure a pressure difference at a desired level between the first housing and the second housing. It is generally not possible to ensure perfect sealing and it is even not always desirable to ensure perfect sealing. The present disclosure aims to facilitate management of the sealing.

Document EP 0 387 122 A1 describes a sealing device comprising:
a ring, the ring presents a substantially annular form extending around an axis of revolution extending along a longitudinal direction, the ring comprises a main sealing lip and a secondary sealing lip, the main sealing lip presents an inner surface configured to come into contact radially with an annular surface of a shaft, the secondary sealing lip presents a radial surface extending perpendicularly to the longitudinal direction, and
a casing, the casing is configured to be sealingly maintained in relation to a separation wall, the casing comprises a cylindrical portion and a radial portion, the cylindrical portion extends along the longitudinal direction around the ring, the radial portion presents a contact surface extending perpendicularly to the longitudinal direction, the ring being biased so as to apply the radial surface of the secondary sealing lip against the contact surface of the casing.

### STATEMENT OF THE DISCLOSURE

In accordance with the disclosure, the sealing device presents at least one leakage path forming a communication between the first housing and the second housing, the at least one leakage path extending between the secondary sealing lip and the radial surface of the casing.

Thus, when a sealing device designed and developed for ensuring high sealing at a given location has performed satisfactorily, the creation of a leakage path makes it possible to adapt it effectively to ensure a lower sealing at another location of the turbomachine. The same reasoning also applies for the adaptation to a turbomachine or another device.

In addition, the secondary sealing lip and the casing make hardly any relative movements, only low-amplitude vibrations because they are substantially fixed, unlike the shaft, which is mobile in rotation around the axis of revolution. Wear of the sealing lip and casing due to contact between the radial surface and the contact surface is therefore low. Consequently, the leakage path changes very little during use.

According to another feature in accordance with the disclosure, the ring presents at least one groove formed in the secondary sealing lip and forming the at least one leakage path.

The secondary sealing lip generally presents a higher wear resistance than the main sealing lip. Thus, the leakage path changes less over time.

In various embodiments of the sealing device according to the disclosure, one may possibly also have recourse to one and/or the other of the following arrangements:
the ring comprises a plurality of segments, each forming a portion of a circle;
the at least one leakage path presents a depth of between 0.1 and 1 mm along the longitudinal direction;
the sealing device comprises between 3 and 15 leakage paths;
the at least one leakage path extends perpendicularly to the longitudinal direction;
the at least one leakage path presents a rectangular cross-section;
the at least one leakage path presents a semi-circular cross-section;
the at least one leakage path presents a triangular cross-section;
the at least one leakage path presents a wavy cross-section.

The present disclosure also relates to a turbomachine comprising the sealing device.

### BRIEF DESCRIPTION OF THE FIGURES

Other features and advantages of the present disclosure will appear in the following detailed description, referring to the attached drawings in which:

FIG. 1 schematically represents a turbomachine comprising a sealing device.

FIG. 2 represents, at enlarged scale, the area marked Il in FIG. 1 and in particular the sealing device according to a first embodiment comprising a plurality of circular segments.

FIG. 3 represents, at an even more enlarged scale, the sealing device according to the first embodiment.

FIG. 4 represents, in perspective, one of the circular segments of the sealing device according to the first embodiment,

FIG. 5 is a view according to the arrow marked V in FIG. 4.

FIG. 6 illustrates a first variation of the first embodiment, in accordance with FIG. 5.

FIG. 7 illustrates a second variation of the first embodiment, in accordance with FIG. 5.

FIG. 7 illustrates a third variation of the first embodiment, in accordance with FIG. 5.

FIG. 8 illustrates a single-piece ring according to a second embodiment of the sealing device.

### DETAILED DESCRIPTION OF THE DISCLOSURE

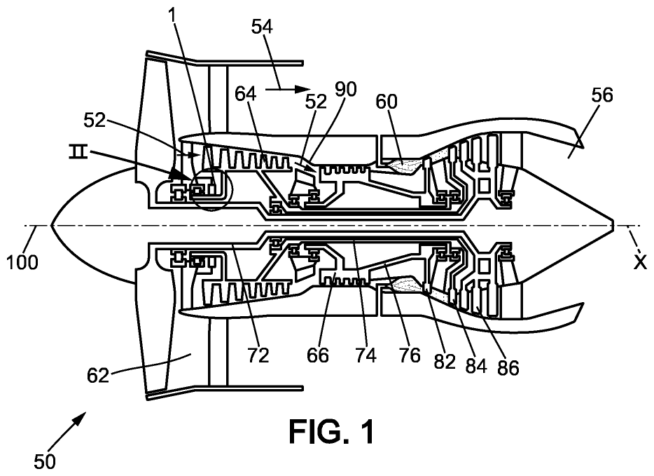

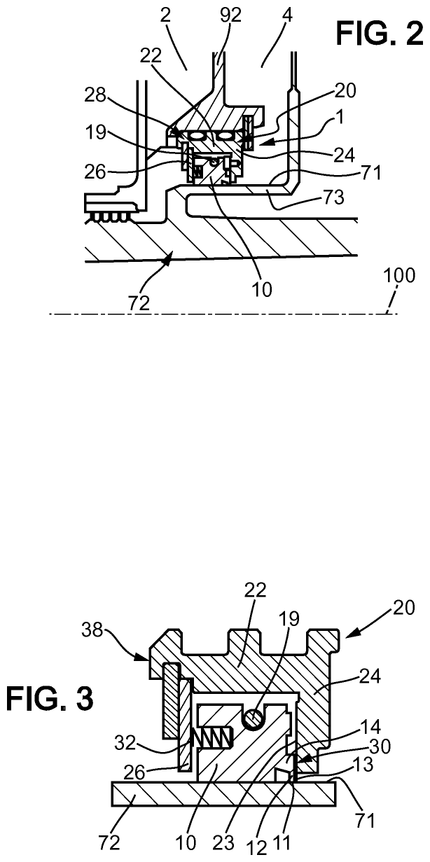

FIG. 1 represents a turbomachine 50 comprising a sealing device 1. Air entering turbomachine 50 crosses a fan 62, and then is separated into a primary flow 52 and a secondary flow 54.

Primary flow 52 successively crosses a set of compressors in a combustion chamber 60, and then a set of turbines. In the embodiment illustrated, the set of compressors comprises a low-pressure compressor 64 and a high-pressure compressor 66, and the set of turbines comprises a first turbine 82, a second turbine 84 and a third turbine 86. Fan 62 is connected to third turbine 86 which rotates it by means of a first stub shaft 72 around an axis of revolution 100 in relation to a stator 90. Low-pressure compressor 64 is connected to second turbine 84 which rotates it by means of a second stub shaft 74 around the axis of revolution in relation to stator 90. High-pressure compressor 66 is connected to first turbine 82 which rotates it by means of a third stub shaft 76 around the axis of revolution 100 in relation to stator 90.

Combustion chamber 60 is supplied with fuel that is burned in primary flow 52. The combustion gases form an output flow 56 downstream from combustion chamber 60. Output flow 56 passes through first turbine 82, second turbine 84, and third turbine 86. Third turbine 86 comprises several stages, each comprising a distributor and a rotor.

Sealing device 1 effects the sealing between a first housing 2 and a second housing 4. A separation wall 92 of the stator separates first housing 2 and second housing 4.

First shaft 72 comprises a cylindrical bearing surface 73. Cylindrical bearing surface 73 presents an annular surface 71 surrounded on the outside by sealing device 1. Sealing device 1 essentially comprises a ring 10 and a casing 20. Casing 20 comprises a cylindrical portion 22 and a radial portion 24. In a variation, casing 20 may also further comprise an annular spinner connected to the radial portion 24. Cylindrical portion 22 extends along the longitudinal axis X around ring 10. Perpendicularly to the longitudinal direction X, cylindrical portion 22 is disposed between ring 10 and separation wall 92. Casing 20 is fixed to separation wall 92. O-rings ensure sealing between cylindrical portion 22 and separation wall 92. Radial portion 24 presents a contact surface 23 extending perpendicularly to the longitudinal direction X.

Ring 10 presents an annular shape centered on axis of revolution 100. Ring 10 comprises a main sealing lip 12 and a secondary sealing lip 14. Main sealing lip 12 presents an inner surface 11. Inner surface 11 of the sealing lip is facing annular surface 71. Inner surface 11 of main sealing lip 12 is substantially in contact with annular surface 71. Secondary sealing lip 14 comprises a radial surface 13 extending perpendicularly to the longitudinal direction X.

Ring 10 is maintained along the longitudinal direction X in relation to casing 20 between radial portion 24 and an opposite end formed by a lock ring 26 maintained in cylindrical portion 22 by an elastic ring. Compression springs 32 are distributed around the axis of revolution 100 and extend along the longitudinal direction X between retaining ring 26 and cavities made in ring 10. Compression springs 32 bias ring 10 along the longitudinal direction X, in order to press radial surface 13 of ring 10 against contact surface 23 of casing 20.

Pins may be provided to prevent the rotation of ring 10 around the axis of revolution 100 in relation to casing 20.

Ring 10 is preferably made of carbon and casing 20 is preferably made of steel.

Sealing device 10 further presents leakage paths 30 extending between ring 10 and casing 20. The number of leakage paths 30 is preferably between 3 and 15. In the embodiments illustrated, the sealing device comprises twelve leakage paths. The total cross-sectional area of leakage paths 30 is preferably between 0.5 mm² and 10 mm². Leakage paths 30 preferably extend perpendicularly to the longitudinal direction X, radially to the axis of revolution 100.

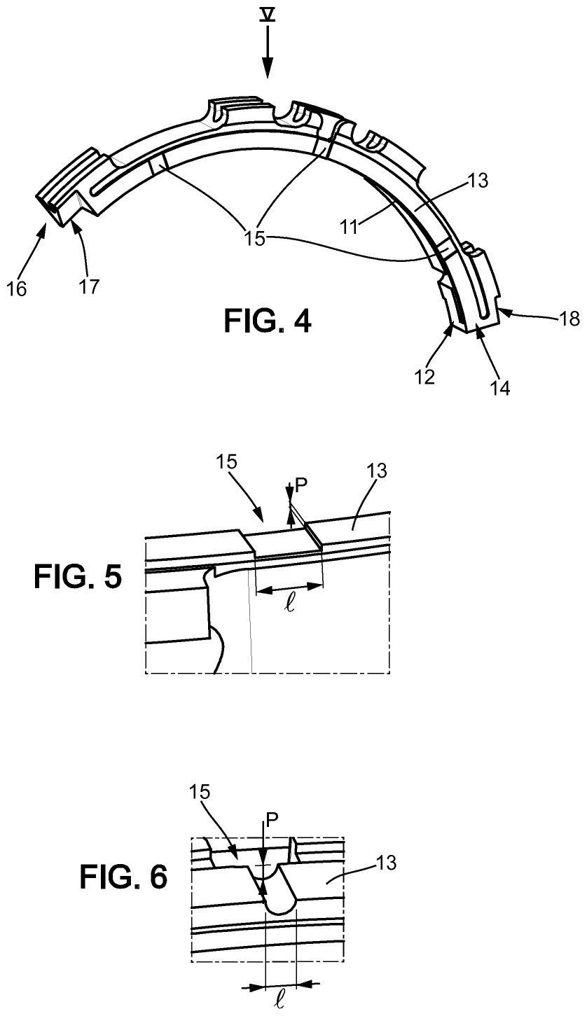

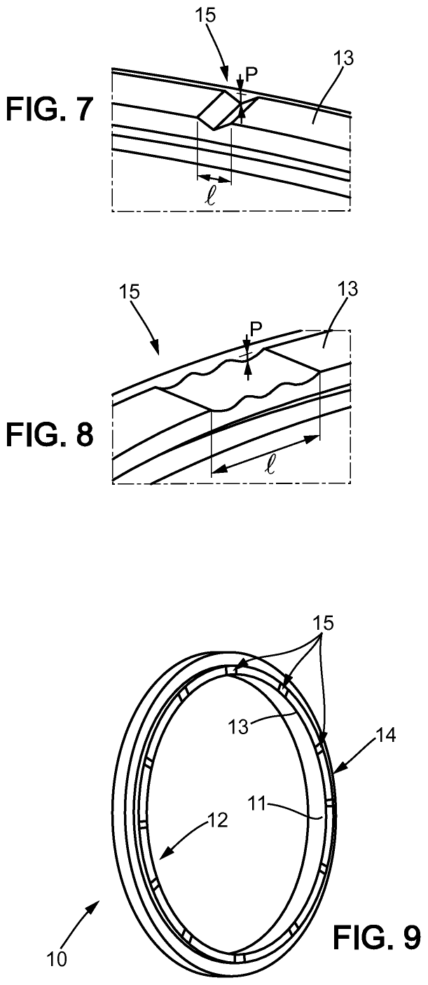

In the embodiments illustrated, leakage paths 30 are formed by grooves 15 made in secondary sealing lip 14. Grooves 15 each present a depth p, along the longitudinal direction X, of between 0.1 mm and 1 mm. A maximum axial wear of secondary sealing lip 14 is planned that may reach 50 μm along the longitudinal direction X. Grooves 15 preferably extend over a width I of between 0.5 mm and 5 mm. Grooves 15 preferably present, perpendicularly to the axis of revolution 100, a rectangular cross-section as illustrated in FIGS. 4 and 5, a semi-circular cross-section as illustrated in FIG. 6, a triangular cross-section as illustrated in FIG. 7, or a wavy cross-section, such as the scalloping as illustrated in FIG. 8.

In the embodiment illustrated in FIG. 4, ring 10 comprises a plurality of segments 16, more specifically three segments in the embodiment illustrated. An annular spring 19, held in a groove, exerts pressure on segments 16 which tends to apply inner surface 11 against annular surface 71 of first stub shaft 72. Each segment 16 comprises, at its ends, a first cover portion 17 and a second cover portion 18 extending at an angle. First cover portion 17 of a segment cooperates with second cover portion 18 of an adjacent segment 16 to form a tertiary sealing. In the embodiment illustrated in FIG. 4, sealing device 1 is formed by a segmented radial seal. In a variation, sealing device 1 may in particular be formed by a fragmented seal or an Arch-bound segmented radial seal.

In the second embodiment illustrated in FIG. 9, ring 10 is a single-piece annular ring, known as a floating ring seal.

Of course, the disclosure is in no way limited to the embodiments described for illustrative, non-limiting purposes. Thus, although this is not preferred, groove 15 may alternatively or also (complementarily) be made on radial surface 13 of casing 20.

1. A sealing device for a turbomachine for providing a seal between a first housing and a second housing, said sealing device comprising:
a ring, the ring presents a substantially annular form extending around an axis of revolution extending along a longitudinal direction, the ring comprising a main sealing lip and a secondary sealing lip, the main sealing lip presents an inner surface configured to be in contact radially with an annular surface of a shaft, the secondary sealing lip presents a radial surface extending perpendicularly to the longitudinal direction, and
a casing, the casing configured to be sealingly maintained in relation to a separation wall, the casing comprising a cylindrical portion and a radial portion, the cylindrical portion extends along the longitudinal direction around the ring, the radial portion presents a contact surface extending perpendicularly to the longitudinal direction, the ring being biased so as to apply the radial surface of the secondary sealing lip against the contact surface of the casing, wherein the sealing device presents at least one leakage path forming a communication between the first housing and the second housing, the at least one leakage path extending between the secondary sealing lip and the radial surface of the casing.

2. The sealing device according to claim 1 wherein the ring presents at least one groove formed in the secondary sealing lip and forming the at least one leakage path.

3. The sealing device according to claim 1, wherein the ring comprises a plurality of segments, each forming a portion of a circle.

4. The sealing device according to claim 1, wherein the at least one leakage path presents a depth of between 0.1 and 1 mm along the longitudinal direction.

5. The sealing device according to claim 1, wherein the at least one leakage path extends perpendicularly to the longitudinal direction.

6. The sealing device according to claim 1, wherein the at least one leakage path presents a rectangular cross-section.

7. The sealing device according to claim 1, wherein the at least one leakage path presents a semi-circular cross-section.

8. The sealing device according to claim 1, wherein the at least one leakage path presents a triangular cross-section.

9. The sealing device according to claim 1, wherein the at least one leakage path presents a wavy undulated cross-section.

10. A turbomachine comprising a first housing, a second housing, a separation wall extending between the first housing and the second housing, a shaft having an annular surface and a sealing device, wherein sealing device comprises:
a ring, the ring presents a substantially annular form extending around an axis of revolution extending along a longitudinal direction, the ring comprises a main sealing lip and a secondary sealing lip, the main sealing lip presents an inner surface being in contact radially with the annular surface of the shaft, the secondary sealing lip presents a radial surface extending perpendicularly to the longitudinal direction, and
a casing, the casing is sealingly maintained in relation to the separation wall, the casing comprises a cylindrical portion and a radial portion, the cylindrical portion extends along the longitudinal direction around the ring, the radial portion presents a contact surface extending perpendicularly to the longitudinal direction, the ring being biased so as to apply the radial surface of the secondary sealing lip against the contact surface of the casing,
wherein the sealing device presents at least one leakage path forming a communication between the first housing and the second housing, the at least one leakage path extending between the secondary sealing lip and the radial surface of the casing.
